(19) United States
(12) Patent Application Publication
(10) Pub. No.: US 2015/0158219 A1
(43) Pub. Date: Jun. 11, 2015

(54) Method for Producing Beverage Crates made of Plastic

(71) Applicant: Stortebeker Braumanufaktur GmbH, Stralsund (DE)

(72) Inventors: Jürgen Nordmann, Rambin (DE); Karsten Triebe, Rambin (DE); Markus Berberich, Altefahr (DE)

(73) Assignee: STÖRTEBEKER BRAUMANUFAKTUR GMBH, Stralsund (DE)

(21) Appl. No.: 14/356,942

(22) PCT Filed: Nov. 8, 2012
(86) PCT No.: PCT/EP2012/004644

§ 371 Date: May 8, 2014

(30) Foreign Application Priority Data
Nov. 8, 2011 (DE) 10 2011 117 827.2

(51) Int. Cl. B29C 45/14

(52) U.S. Cl. CPC B29C 45/14008; B29C 45/14

(57) ABSTRACT

A method for producing beverage crates made of plastic with the look and feel of a beverage crate made of a material other than plastic, in which the base bodies of the beverage crate are injection-molded and in which films are applied in a laminar manner all over to the outsides of the side walls of the base bodies and are connected with the outsides of the base bodies, wherein the injection mold is provided such that it provides the outsides of the side walls all over with a characteristic surface structure of the material that the beverage crate should look and feel like and the films with a photo-realistic image of the material with the same characteristic surface structure aligned with the surface structure of the side walls are applied to the outsides of the side walls and are connected with the outsides.

### CROSS-REFERENCE TO RELATED APPLICATIONS

This is a national stage application of PCT/EP2012/004644, filed on Nov. 8, 2012 which claims priority to DE 10 2011 117 827.2, filed on Nov. 11, 2011.

### STATEMENT REGARDING FEDERALLY SPONSORED RESEARCH

Not applicable.

### BACKGROUND OF THE INVENTION

The invention relates to a method for producing beverage crates made of plastic.

Beverage crates serve to transport a plurality of beverage bottles. For example, beverage crates for 20×0.5 l beer bottles or for 24×0.33 l beer bottles are known. Beverage crates used to be made of wood. Today, beverage crates are generally made of plastic. Beverage crates are usually used for deposit bottles. The consumer pays a deposit for the deposit bottles and for the beverage crate when purchasing a beverage crate.

Beverage crates have a rectangular bottom and side walls protruding up from the edges of the bottom. The side walls can be more or less closed. They are provided with carry openings for holding and carrying the beverage crates. The side walls can also be designed in a frame-like manner with vertically protruding posts and horizontal frame parts. The horizontal frame parts can be held for carrying.

Vertical separating walls protrude up from the bottom of known beverage crates, which delimit dividers for the insertion of bottles. Furthermore, beverage crates are known, in which quills protrude from the bottom in order to separate bottle storing positions from each other. Furthermore, there are bottle crates in which quills and separating walls protrude from the bottom. Furthermore, bottle crates are known that have quills and half-quills protrude from the bottom and projections that reach at most the height of support thresholds. Beverage crates with quills are suitable in particular for insertion of bottles in multipacks made of cardboard, which take several bottles.

For forming stable stacks of bottle crates, they usually have a base protruding from the bottom side, which is insertable into the opening between the side walls on the top side of another bottle crate, wherein the edge areas of the bottom protruding laterally from the base are supported on the upper edge of the lower bottle crate.

Bottle crates are provided with imprints, which concern e.g. the manufacturer, the brand or respectively other information.

It is already known to apply an imprint to a beverage crate by means of an in-mold label. This is a film, which is printed with the brand and is molded by film insert molding in a recess with a smooth surface of an injection mold with the material of the beverage crate. A high-quality rendition of the brand is achieved in this manner.

DE 20 2009 015 066 U1 describes a bottle crate, which has a recess on a side wall, in which an in-mold label is received and is permanently connected with the side wall of the crate. The film is completely covered with an overprint layer made of transparent plastic on its exposed outside, wherein the plastic overlay completely overlaps the film embedded into the plastic of the crate side wall in order to effectively protect the film with its visible surface, which is printed or provided with a decoration, from damage.

DE 10 2005 036 258 A1 describes a decorative film and a method for its production as well as a beverage crate made of plastic, which has the decorative film.

Furthermore, a beverage crate made of plastic is known that looks like a beverage crate made of wood. The known beverage crate has a perforated frame made of horizontal boards and vertical posts, which has the surface structure of wood. The beverage crate is printed using the screen printing method and looks like bright, fresh wood. Due to the manufacturing process, the quality of the wood appearance of the beverage crate is only moderate.

### BRIEF SUMMARY OF THE INVENTION

Against this background, an object of the invention is to provide a method for producing beverage crates made of plastic with which beverage crates with an improved quality can be given the look and feel of beverage crates made of a material other than plastic.

In the case of the method for producing beverage crates made of plastic with the look and feel of a beverage crate made of a material other than plastic,
the base body of the beverage crate is injection-molded, wherein the injection mold is to be provided such that it provides the outsides of the side walls all over with a characteristic surface structure of the material that the beverage crate should look and feel like, and
films with a photo-realistic image of the material with the same characteristic surface structure are applied all over in a laminar manner to the outsides of the side walls of the base bodies aligned with the surface structure of the beverage crate and are connected with the outsides of the base bodies.

In the case of the method according to the invention, it is achieved in a particularly high-quality manner that the beverage crates obtain the look and feel of a beverage crate made of a material other than plastic. For this, the beverage crates are namely not only provided with a characteristic surface structure of the material that the beverage crates should look and feel like all over on the outsides of the side walls. Additionally, films that have a photo-realistic image of the material with the same surface structure are applied all over in a laminar manner to the structured outsides of the base bodies and are connected with them. During application of the films, the photo-realistic image of the material is aligned exactly on the corresponding surface structure of the side walls created during the injection-molding. Through the overlapping of the surface structure and the photo-realistic image of the same surface structure, the beverage crates receive a very high-quality or respectively almost deceiving look and feel of a beverage crate made of a material other than plastic. The method according to the invention produces beverage crates, in which the outsides of the side walls are designed three-dimensionally according to the surface structure of the material that the beverage crate should look and feel like. In combination with the photo-realistic image of the same surface structure overlapping the surface structure, this leads to an appearance of the beverage crate, which is deceptively similar to the appearance of the original material that the beverage crate should look and feel like. Even the feel of the beverage crate is greatly improved with respect to the feel of conventional beverage crates with smooth outside and comes very close to the feel of a beverage crate made of the original material. In particular, beverage crates made of plastic that look and feel deceptively like beverage crates made of wood can be produced with the method according to the invention.

The characteristic surface structure is a surface structure by which one can easily recognize a certain material. If the material can have different surface structures, the characteristic surface structure is a typical surface structure that enables the identification of the material. The photo-realistic image is preferably a photograph or a computer graphic.

The application of the film to the outside so that it lies in a laminar manner on the surface structure takes place according to one embodiment through pressing on. According to another embodiment, it takes place by applying a vacuum. The connection of the film with the outside takes place according to a further embodiment through heat-sealing. The films are preferably thermally heat-sealed with the outsides. Alternatively, they are glued.

According to one embodiment of the method, the films applied to the base body have a base film carrying the image and a protective film covering the image. The protective film is applied after the printing of the base film. This prevents the quality of the image from being impaired during use. It ensures the high quality of the outer appearance of the beverage crate.

According to a further embodiment, the films or respectively base films are printed in a rotogravure method. A very high quality image is hereby achieved.

According to a further embodiment, beverage crates with the look or respectively feel of a wood crate or a metal crate or a brick crate or a crate made of netting or a crate made of textile are produced according to the method according to the invention. According to the method, beverage crates are preferably produced with the look or respectively feel of a beverage crate made of a natural material (e.g. wood).

According to a further embodiment, the outsides of the side walls are provided completely or almost completely with the characteristic surface structure of the material that the beverage crates should look and feel like, and films with the photo-realistic image of the material with the same characteristic surface structure are applied all over or almost all over the outsides of the side walls. “Almost completely” or “almost all over” preferably means at least 90%, furthermore preferably at least 95% of the surface of the side walls.

According to a further embodiment, at least one label is applied on at least one side wall to the outside of a film. The label is for example a label made of plastic and/or paper. Through the application of the label to the outside of the film, the three-dimensional design of the surface and the approximation of a beverage crate made of the original material are further improved. The label is applied for example through gluing and/or through sealing to the outside of the film.

Furthermore, the invention includes a method, in which the insides of the sides walls of the base bodies are provided with the characteristic surface structure of the material that the beverage crates should look and feel like and in which films with a photo-realistic image of the material with the same characteristic surface structure are applied all over in a laminar manner to the insides of the side walls of the base bodies aligned with the surface structure of the beverage crates and are connected with the insides of the base bodies. In the case of this embodiment of the method, the beverage crates have on the outside and the insides the look and feel of the beverage crates made of the original material. This embodiment is particularly advantageous for beverage crates that do not have any dividers on the inside but rather only quills protruding from the bottom wall and/or projections and/or separating walls and/or recesses in the bottom wall. In the case of these beverage crates, the insides of the separating walls can be covered completely or almost completely with films.

In the case of the method for producing beverage crates made of plastic with the look and feel of a beverage crate made of a material other than plastic,
an injection mold is provided for the injection-molding of the beverage crate, which is provided such that it provides the outsides of the side walls of the beverage crates all over with a characteristic surface structure of the material that the beverage crates should look and feel like,
films are inserted into the injection mold, which have a photo-realistic image of the material with the same characteristic surface structure, wherein the films are aligned with the image with the surface structure of the beverage crate and
the beverage crate is produced in the injection mold through film insert molding of the films.

In the case of this method, the beverage crate is produced through film insert molding of films with the appearance of a beverage crate made of a certain material. The technique also used in “in-mold labeling” is generally thereby used. It is hereby important that the surface structures visible in the images on the films are aligned exactly with the corresponding surfaces structures of the mold. During the film insert molding of the films, the surface structures are generated to fit the image and a connection of the material of the base body of the beverage crate with the films is simultaneously achieved.

The invention is explained in the following in more detail using exemplary embodiments in the drawings. The drawings show:

### BRIEF DESCRIPTION OF THE SEVERAL VIEWS OF THE DRAWINGS

FIG. 1 a beverage crate in a perspective view diagonally from the top and from the side;

FIG. 2 a horizontal partial section through a side wall of the beverage crate.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

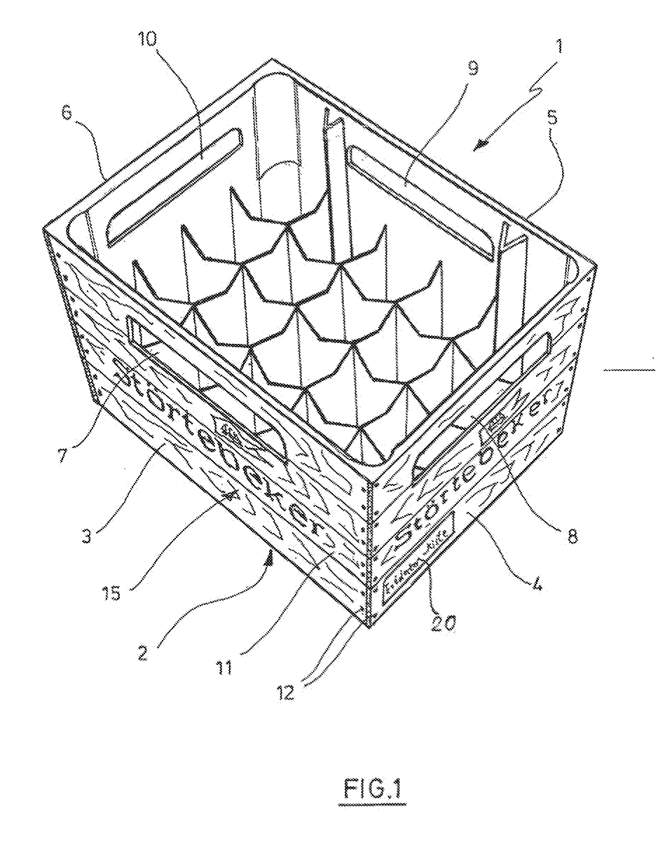

According to FIG. 1, a beverage crate 1 has at least one bottom wall 2 and four side walls 3, 4, 5, 6 protruding from the edges of the bottom wall 2. Handle openings 7, 8, 9, 10 are present in the side walls 3, 4, 5, 6 below the upper edges.

The side walls 3 to 6 have the appearance of a wall made of wooden boards 11. In the edge areas, the surface structure has the structure of nails 12 or other fastening means like wood pegs.

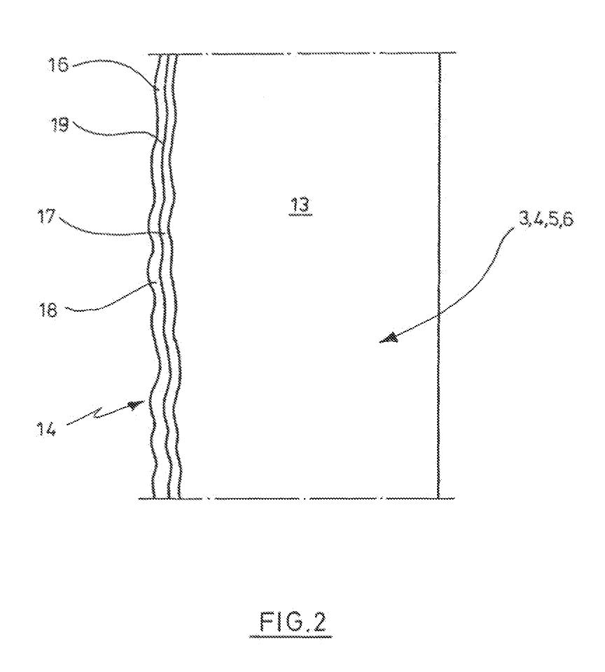

According to FIG. 2, the appearance of a wood crate is achieved in that a base body 13 of the beverage crate 1 has on the outside 14 a surface structure 15 structured according to the wooden board construction. The surface structure 15 is created by means of suitably shaped injection molds during the injection-molding of the base body 13.

Furthermore, films 16 that comprise a base film 17 and a protective film 18 are applied on the outsides. The side of the base film 17 covered by the protective film 18 carries the image 19 of the wooden board construction, the surface structure 15 of which is present on the outsides of the base body 13. The films are aligned exactly with the image 19 on the surface structure 15 and are connected in a laminar manner with the base body 13 through pressing on and/or under vacuum and through heat-sealing.

A label 20 with information on the beverage product is glued or sealed onto the side wall 4.

The beverage crate 1 thus has the deceptive look and feel of a beverage crate with side walls made of wooden boards. The quality of the photographs is protected by the protective film 18.

This completes the description of the preferred and alternate embodiments of the invention. Those skilled in the art may recognize other equivalents to the specific embodiment described herein which equivalents are intended to be encompassed by the claims attached hereto.

1. A method for producing beverage crates made of plastic with the look and feel of a beverage crate made of a material other than plastic, in which
the base bodies of the beverage crate are injection-molded and
in which films are applied in a laminar manner all over to the outsides of the side walls of the base bodies and are connected with the outsides of the base bodies, wherein
the injection mold is provided such that it provides the outsides of the side walls all over with a characteristic surface structure of the material that the beverage crate should look and feel like and
the films with a photo-realistic image of the material with the same characteristic surface structure are applied in alignment of the image with the surface structure of the side walls to the outsides of the side walls and are connected with the outsides.

2. The method according to claim 1 in which the films are applied in a closely fitting manner to the outsides through pressing onto the outsides and/or through application of a vacuum.

3. The method according to claim 1, in which the films are connected through heat-sealing with the base bodies.

4. The method according to claim 1, in which the films comprise a base film carrying the image and a protective film covering the image.

5. The method according to claim 1, in which the films are printed in a rotogravure method.

6. The method according to claim 1, in which the beverage crates are produced with the look of a wood crate or a metal crate or a brick crate or a crate made of netting or a crate made of textile.

7. The method according to claim 1, in which the side walls are completely provided with the characteristic surface structure of the material that the beverage crates should look and feel like and in which the films are completely connected with the outsides of the side walls.

8. The method according to claim 1, in which at least one label is applied to at least one side wall on the outside of the film.

9. The method according to claim 1, in which the insides of the sides walls of the base bodies are provided with the characteristic surface structure of the material that the beverage crates should look and feel like and in which films with a photo-realistic image of the material with the same characteristic surface structure are applied all over in a laminar manner to the insides of the side walls of the base bodies aligned with the surface structure of the beverage crates and are connected with the insides of the base bodies.

10. The method according to claim 1, in which
an injection mold is provided for the injection-molding of the beverage crate, which is provided such that it provides the outsides of the side walls of the beverage crates all over with a characteristic surface structure of the material that the beverage crates should look and feel like,
films are inserted into the injection mold, which have a photo-realistic image of the material with the same characteristic surface structure, wherein the films are aligned with the surface structure of the beverage crate and
the beverage crate is produced in the injection mold through film insert molding of the films.
